(19) United States
(12) Patent Application Publication
(10) Pub. No.: US 2011/0240926 A1
(43) Pub. Date: Oct. 6, 2011

(54) METHOD FOR OXIDATIVE COUPLING OF METHANE AND PRODUCING SYNGAS

(75) Inventors: Ralph Schellen, Dormagen (DE); Leslaw Mleczko, Dormagen (DE); Evin Hizaler Hoffmann, Koln (DE); Stephan Schubert, League City, TX (US)

(73) Assignee: BAYER TECHNOLOGY SERVICES GMBH, LEVERKUSEN (DE)

(21) Appl. No.: 13/132,393

(22) PCT Filed: Dec. 5, 2009
(86) PCT No.: PCT/EP2009/008697

§ 371 Date: Jun. 2, 2011

(30) Foreign Application Priority Data
Dec. 20, 2008 (DE) 1020080642754

(51) Int. Cl. C01B 3/26

(52) U.S. Cl. 252/373

(57) ABSTRACT

Process for preparing hydrogen and carbon monoxide (synthesis gas) by endothermic, catalytic gas phase oxidation of hydrocarbons with steam and carbon dioxide, and for simultaneous preparation of ethylene by exothermic, heterogeneously catalyzed, oxidative coupling of methane, wherein the particular reactions are performed in at least three series-connected reaction zones under adiabatic conditions, and wherein the heat of reaction of the exothermic, heterogeneously catalyzed, oxidative coupling of methane is supplied to the endothermic, catalytic gas phase oxidation of hydrocarbons with steam and carbon dioxide.

The present invention relates to a process for preparing hydrogen and carbon monoxide (synthesis gas) by endothermic, catalytic gas phase oxidation of hydrocarbons with steam and carbon dioxide, and for simultaneous preparation of ethylene by exothermic, heterogeneously catalysed, oxidative coupling of methane, wherein the particular reactions are performed in at least three series-connected reaction zones under adiabatic conditions, and wherein the heat of reaction of the exothermic, heterogeneously catalysed, oxidative coupling of methane is supplied to the endothermic, catalytic gas phase oxidation of hydrocarbons with steam and carbon dioxide.

The aforementioned synthesis gas consists essentially of carbon monoxide and hydrogen, but may also comprise carbon dioxide.

Component reactions essential for the preparation of synthesis gas from hydrocarbons are shown by way of example in the formulae (I to III) below. The formulae relate to the conversion of methane as the hydrocarbon. For homologues of the hydrocarbon methane, correspondingly stoichiometrically corrected formulae apply, but these are likewise common knowledge.

CH₄+H₂O [symbol] CO+3.H₂ (I)

CO+H₂O [symbol] CO₂+H₂ (II)

CH₄+2.H₂O [symbol] CO₂+4.H₂ (III)

The reactions according to the formulae (I) and (III) are strongly endothermic and represent the significant reactions in connection with synthesis gas preparation. The reaction according to formula (II) is the reaction formula known to those skilled in the art under the name “water-gas shift reaction” and is exothermic. All three reactions according to the formulae (I to III) are equilibrium-limited.

The synthesis gas obtained from the reactions, for instance according to the formulae (I to III), constitutes an essential starting material for further conversion, for example, to long-chain hydrocarbons by the Fischer-Tropsch process.

The controlled supply of heat in processes for obtaining synthesis gas is important since the position of the equilibria of the aforementioned reactions according to the formulae (I to III) is highly dependent on the temperature of the reaction zone, and hence the yields and/or selectivities for hydrogen and/or carbon monoxide can be controlled as a result.

An uncontrolled temperature decline as a result of the endothermic reactions according to the formulae (I) and/or (III) can thus promote the formation of greater or lesser amounts of carbon dioxide, which is disadvantageous for the further use of the synthesis gas, for instance, for the abovementioned Fischer-Tropsch process. In other ranges of disadvantageous temperatures, less hydrogen may be formed, which, when this is desired as an alternative to the preparation of synthesis gas, may likewise be disadvantageous. In general, the reactions according to the formulae (I to III) must therefore be performed under very controlled temperature conditions in order to obtain advantageous yields and/or selectivities for the desired reaction products. This is especially true when the product should be synthesis gas.

It is therefore advantageous to control the temperature of the reaction zones in the course of the process for preparing synthesis gas at a level which enables rapid conversion with minimization of side reactions.

As just described, synthesis gas constitutes a significant starting material for processes for preparing longer-chain hydrocarbons by means of a Fischer-Tropsch synthesis. In a first step, for instance, ethane and/or ethylene can thus be prepared from the synthesis gas. Such ethane and/or ethylene can, however, also be obtained by oxidative coupling of methane.

Illustrative component reactions essential for the exothermic, heterogeneously catalysed, oxidative coupling of methane to ethylene are shown in the formulae (IV and V).

4.CH₄O₂→2.C₂H₆+2.H₂O (IV)

2.CH₄+O₂→C₂H₄+2.H₂O (V)

The reactions according to the formulae (IV and V) are strongly exothermic, the reactions according to the formulae (IV and V) having different activation energies in the presence of identical catalyst materials, such that the exact setting of a reaction temperature can control the yield of the products from the reaction according to the formula (IV) or according to the formula (V). In connection with the present invention, a maximization of the yield of ethylene as the reaction product of the reaction according to the formula (V) is desired.

The combination of the reactions according to the formulae (I to III) with the reactions according to the formulae (IV and V) has the result, considering the reactants, that methane can be converted by means of one endothermic and one exothermic process to longer-chain hydrocarbons with a combined process.

Typically, such hydrocarbons are nowadays prepared from methane by means of preparation of synthesis gas and subsequent Fischer-Tropsch synthesis, especially supplying the preparation of synthesis gas with the heat of reaction needed by firing, for instance by the combustion of methane, the methane being converted to carbon dioxide and water in the course of firing, and the carbon dioxide usually being released into the atmosphere as an environmentally damaging gas. In addition to environmental damage, however, it is disadvantageous to proceed in such a way in particular because the carbon dioxide constitutes an essentially inert gas which cannot easily be used widely in such a manner as to deliver value. This firing thus also constitutes an economic disadvantage.

It would thus be advantageous overall if the methane, or homologues thereof, is not used solely for the generation of heat, but if an integrated process were to form both heat and a product of value which can be used in equivalent further processes.

Considering first the preparation of synthesis gas, it is common knowledge to the person skilled in the art that the aforementioned reactions according to the formulae (I to III) do not exhaustively represent the possible reactions in a reaction zone.

A very comprehensive overview over the multitude of reaction mechanisms possibly involved here is given, for instance, by A. M. De Groote and G. F. Froment in “Reactor Modeling and Simulations in Synthesis Gas Production”, published in Reviews in Chemical Engineering (1995) 11: 145-183.

The process variants disclosed here relate exclusively to reactions which are performed in fired furnaces, in which tube bundle reactors in which the reactions are performed are present. The processes are accordingly not adiabatic processes. The embodiment as a fired furnace with tube bundles is, however, required in the process according to A. M. De Groote and G. F. Froment.

In addition, A. M. De Groote and G. F. Froment disclose that this results in significant radial and axial temperature profiles in the individual reaction zones. Especially radial temperature profiles are, however, disadvantageous because there exist, as a result, in regions of the reaction zones, sites which are not operated under optimal conditions for the reaction of the hydrocarbons to give synthesis gas. Sufficient control of the temperature in the reaction zones is thus not ensured. Moreover, the reaction apparatuses disclosed by A. M. De Groote and G. F. Froment are of very complex construction, which is likewise disadvantageous since they are at least very expensive. In the event of a fault, however, the apparatus can, in particular, only be brought back into service by shutdown and repair of the overall apparatus.

Since exact temperature control is apparently impossible, there may additionally, for instance as a result of the exothermic reaction according to the formula (II), be local excess temperatures in the reaction zones, which can damage the reaction apparatus. Together with the aforementioned disadvantage of the necessarily complex construction and the associated necessary shutdown of the entire process in the event of a fault, it follows that the process disclosed by A. M. De Groote and G. F. Froment is highly disadvantageous. Moreover, the aforementioned firing, according to the process of A. M. De Groote and G. F. Froment, is at least economically disadvantageous for the reasons just explained.

EP 1 251 951 (B1) discloses an apparatus and the possibility of performing chemical reactions in the apparatus, the apparatus being characterized by a cascade of reaction zones and heat exchanger apparatuses in contact with one another, which are arranged cohesively connected to one another in an integrated system. The process to be performed here is thus characterized by the contact of the different reaction zones with a particular heat exchanger apparatus in the form of a cascade. There is no disclosure regarding the useability of the apparatus and of the process for preparing synthesis gas and/or for oxidative coupling of methane.

It thus remains unclear how, proceeding from the disclosure of EP 1 251 951 (B1), such reactions are to be performed by means of the apparatus and of the process performed therein. More particularly, no process comprising endothermic reactions is disclosed, nor is a coupling with an exothermic process proceeding from identical reactants.

Moreover, for reasons of unity of invention, it has to be assumed that the process disclosed in EP 1 251 951 (B1) is performed in an apparatus identical or similar to the disclosure regarding the apparatus. The result of this is that, due to the large-area contact of the heat exchange zones with the reaction zones according to the disclosure, a significant amount of heat is transferred by conduction of heat between the reaction zones and the adjacent heat exchange zones.

The disclosure regarding the oscillating temperature profile can thus only be understood such that the temperature peaks found here would be greater if this contact were not to exist. A further indication of this is the exponential rise in the temperature profiles disclosed between the individual temperature peaks. These indicate that a certain heat sink with notable but limited capacity is present in each reaction zone, which can reduce the temperature rise therein. It can never be ruled out that a certain removal of heat (for example by radiation) takes place; however, in the case of a reduction in the possible removal of heat from the reaction zone, there would be indications of a linear temperature profile or one with declining slope, since no further metered addition of reactants is intended and thus, after exothermic complete reaction, the reaction would become ever slower and the exothermicity generated would thus decrease.

Thus, EP 1 251 951 (B1) discloses multistage processes in cascades of reaction zones, from which heat is removed in an undefined amount by conduction of heat. Accordingly, the process disclosed is not adiabatic and is disadvantageous in that exact temperature control of the reaction is impossible. This is especially true of the undisclosed possibility of an endothermic reaction in the reaction zones. An application of the disclosure from A. M. De Groote and G. F. Froment to EP 1 251 951 (B1) would in turn lead to the effect that a firing would be performed in the heat exchange zones disclosed by EP 1 251 951 (B1).

An application of the process disclosed in EP 1 251 951 (B1) to the preparation of synthesis gas using the apparatuses there is disclosed by E. L. C. Seris et al. in “Scaleable, microstructured plant for steam reforming of methane” in Chemical Engineering Journal (2008) 135S:9-16.

This discloses a process using apparatuses according to EP 1 251 951 (B1), in which synthesis gas is prepared in nine reaction zones with heat exchange zones in between. The process variant presented is declared to be multistage and adiabatic, but it is disclosed at the same time that the reaction zones are in direct contact with the heat exchange zones, as has already been disclosed in EP 1 251 951 (B1). Although this leads to an advantageous spatial integration of the reaction zones with the heat exchange zones, this at the same time has the consequence that the term “adiabatic reaction zone” is incorrect. The reaction zones are not adiabatic since they are in direct contact with the heat exchange zones at their boundaries and thus, especially given the considerable temperature gradients between the reaction zones and the heat exchange zones, a significant heat flow takes place, which is not accounted for by the convective transport of the process gases. This is disadvantageous for the purposes of exact temperature control, which is also the subject of the process presented by E. L. C. Seris et al.

E. L. C. Seris et al. also additionally discloses combustion chambers in order to introduce the heat of reaction needed into the process and is thus affected by the fact that the disclosure of EP 1 251 951 (B1) does not give the person skilled in the art any indication of the advantageous coupling as present in the invention detailed here.

Proceeding from the preparation of synthesis gas, it is thus impossible to date to utilize methane in an energetically, environmentally and hence economically advantageous manner.

Considering the preparation of ethane and/or ethylene, DE 32 37 079 (C2), for instance, discloses a process in a fixed bed reactor, in which ethane and/or ethylene can be prepared from methane and oxygen in the presence of heterogeneous catalysts comprising lead oxide, bismuth oxide, aluminium oxide and/or antimony oxide and at temperatures of 500° C. to 900° C. This process is in principle performed in one stage.

DE 32 37 079 (C2) does not disclose whether the process should preferably be implemented adiabatically or isothermally, but since only one single temperature is ever stated for the reaction zone in the working examples, and since no outlet temperature different from the inlet temperature is disclosed for the process gases, a preferentially isothermal implementation has to be assumed.

In addition to the fact that such an isothermal mode of operation of the process disclosed in DE 32 37 079 (C2) no longer ensures temperature control in the event of a fault, for instance in the event of failure of a cooling circuit around the tubular reactor, and hence at least the yield and/or the selectivity for the desired reaction products cannot be ensured, the process disclosed in DE 32 37 079 (C2) is also disadvantageous because the heat of reaction is not utilized.

An overview over the prior art in the field of the oxidative coupling of methane is also given by L. Mleczko and M. Baerns in “Catalytic oxidative coupling of methane—engineering aspects and process schemes” in Fuel Processing Technology 42 (1995) 217-248.

It is disclosed therein that methane can be oxidatively coupled using catalysts comprising lithium and magnesium oxide, or samarium oxide, or lanthanum oxide and calcium oxide, or barium carbonate and lanthanum oxide, or cerium oxide, lithium carbonate and magnesium oxide, or sodium and nickel titanyl oxide. The reaction temperatures, which are different according to the catalyst material, may be from 600° C. to 940° C. It is additionally disclosed that an excess partial pressure of methane compared to oxygen promotes the formation of ethane and/or ethylene.

With regard to the reaction regime, L. Mleczko and M. Baerns disclose that the embodiments as fixed bed reactors under adiabatic conditions are considered to be advantageous.

In connection with such adiabatic embodiments with multistage implementation, it is also disclosed that it is advantageous to introduce the oxygen into the process distributed between the individual stages in order to ensure the aforementioned positive partial pressure conditions of the methane and oxygen process gases in the individual reaction zones. It is simultaneously disclosed that a large amount of cooling medium is required in the heat exchange zones present between the adiabatic reaction zones in such multistage adiabatic embodiments.

The aforementioned need to use large amounts of cooling medium makes the processes according to the disclosure of L. Mleczko and M. Baerns disadvantageous, since it is not possible here, as in the case of the disclosure of DE 32 37 079 (C2), to utilize the heat of reaction.

Proceeding from the prior art, it would thus be advantageous to provide a process for simultaneous preparation of hydrogen and carbon monoxide (synthesis gas), and for simultaneous preparation of ethylene, which can be performed in simple reaction apparatus and which enables exact, simple temperature control of the two processes, such that it allows high conversions of methane with maximum purities of the products while maintaining desired yields and/or selectivities. Such simple reaction apparatus would be easily convertible to an industrial scale and are inexpensive and robust in all sizes.

For a coupled preparation of synthesis gas and ethylene, as just described, no suitable processes which allow this have been demonstrated to date. More particularly, no process which enables optimal utilization of the methane reactant (or homologues thereof) to products which can be used further in equivalent processes with minimization of the production of environmentally damaging carbon dioxide has been disclosed as yet.

It is therefore an object of the present invention to provide a process for coproducing synthesis gas and ethylene, which is performable with exact temperature control in simple reaction apparatus and which as a result allows high conversions at high purities of the product, which minimizes the amount of carbon dioxide produced.

It has been found that, surprisingly, this object is achieved by a process for coproducing synthesis gas by means of endothermic, heterogeneously catalysed gas phase reaction and ethylene by means of exothermic, heterogeneously catalysed, oxidative coupling of methane, characterized in that the endothermic, heterogeneously catalysed preparation of synthesis gas and the exothermic, heterogeneously catalysed, oxidative coupling of methane are performed in at least three separate series-connected pairs of adiabatic reaction zones, a heat exchange zone being present between each pair of adiabatic reaction zones, in which the heat of reaction of the exothermic, heterogeneously catalysed, oxidative coupling of methane from the upstream reaction zone is supplied at least partly through one wall to the process gases of the endothermic, heterogeneously catalysed gas phase reaction to give synthesis gas which have been cooled in the upstream reaction zone.

In the context of the present invention, synthesis gas refers to a process gas which comprises essentially the substances carbon monoxide and hydrogen. The synthesis gas may also comprise proportions of carbon dioxide, steam and hydrocarbons.

In the context of the present invention, hydrocarbons refer to substances present as process gas, consisting of carbon, hydrogen and optionally oxygen. Essentially, such hydrocarbons, however, consist of carbon and hydrogen.

Preferred hydrocarbons which are used as a feedstock in the process according to the invention are those selected from the list consisting of alkanes, alkenes and alkynes.

Particularly preferred hydrocarbons are alkanes. Preferred alkanes are those comprising not more than six carbon atoms, particular preference being given to methane, ethane, propane and butane, very particular preference to methane.

In the context of the present invention, steam refers to a process gas which comprises essentially water in the gaseous state.

In the context of the present invention, oxygen likewise refers to a process gas which comprises at least 10% by weight of oxygen. Preference is given to air or pure oxygen.

In the context of the present invention, ethane and ethylene likewise refer to process gases which comprise ethane and/or ethylene.

The term “essentially” refers, in the context of the present invention, to a proportion by mass and/or a molar proportion of at least 80%.

In the process according to the invention, the synthesis gas is formed in the reaction zones by endothermic, heterogeneously catalysed gas phase reaction of hydrocarbons with steam and carbon dioxide.

Moreover, the ethane and/or ethylene is formed in the process according to the invention by exothermic, heterogeneously catalysed, oxidative coupling of methane with oxygen.

The hydrocarbons used in the process according to the invention, the steam, the oxygen, the methane as the hydrocarbon, the constituents of the synthesis gas and the synthesis gas, and the ethylene and/or ethane, are also referred to hereinafter collectively as process gases.

It follows from this that the entire process according to the invention is in each case performed in the gas phase. Should substances used in the process, for instance particular hydrocarbons, not be in gaseous form at room temperature (23° C.) and ambient pressure (1013 hPa), it can be assumed hereinafter that such substances are converted to the gas phase by increasing the temperature and/or reducing the pressure before or during the use thereof in the process according to the invention.

In addition to the essential components of the process gases, they may also comprise secondary components. Non-exclusive examples of secondary components which may be present in the process gases are, for instance, argon, nitrogen and/or carbon dioxide.

According to the invention, the performance of the process under adiabatic conditions means that essentially no heat is supplied actively to, nor is heat withdrawn from, the reaction zone from outside. It is common knowledge that complete insulation to supply or removal of heat is possible only by complete evacuation with exclusion of the possibility of heat transfer by radiation. In the context of the present invention, “adiabatic” therefore means that no measures for supply or removal of heat are taken.

In an alternative embodiment of the process according to the invention, it is possible, however, to reduce heat transfer, for example by insulation by means of commonly known insulators, for example polystyrene insulating materials, or else by sufficiently great distances from heat sinks or heat sources, in which case the insulator is air.

When pairs of reaction zones are discussed in connection with the present invention, this does not necessarily refer to a spatial pair formation, but to the corresponding number of the appropriate reaction zones. This means that, in the process according to the invention, just as many reaction zones in which the exothermic, heterogeneously catalysed, oxidative coupling of methane with oxygen is performed are present as reaction zones in which the endothermic heterogeneously catalysed gas phase reaction to give synthesis gas is performed. The aforementioned pairs in connection with this present invention are also not intended to indicate that the reaction zones of a pair are necessarily in a direct relationship in terms of process technology, which is clarified hereinafter more particularly with reference to the different possible flow regimes in the process according to the invention.

When these pairs, in a preferred development of the present invention, are also arranged in spatial proximity to one another, a thermal insulation zone in the sense of the alternative embodiment just described is provided between these reaction zones, such that heat transfer is substantially prevented and adiabatic operation can be ensured.

One advantage of the inventive adiabatic mode of operation of at least three series-connected pairs of reaction zones over a nonadiabatic mode of operation is that no means of heat supply need be provided in the reaction zones, which implies a considerable simplification of the construction. This gives rise, more particularly, to simplifications in the manufacture of the reactor and in the scaleability of the process, and a rise in the reaction conversions.

A further advantage of the process according to the invention is the possibility of very exact temperature control, by virtue of a close graduation of adiabatic reaction zones and heat exchange zones. It is thus possible to establish and control a temperature which is advantageous in the reaction progress in each reaction zone.

Moreover, the heat of reaction of the exothermic, heterogeneously catalysed, oxidative coupling of methane with oxygen can be used in an advantageous manner in order to supply the endothermic heterogeneously catalysed gas phase reaction to synthesis gas with the heat of reaction needed.

The catalysts used for the endothermic, heterogeneously catalysed gas phase reaction to give synthesis gas are typically catalysts which consist of a material which, in addition to its catalytic activity for the reaction according to the formulae (I to III), is characterized by sufficient chemical resistance under the conditions of the process, and by a high specific surface area. This also applies to the catalysts which are used for the exothermic, heterogeneously catalysed, oxidative coupling of methane with oxygen for the reaction according to the formulae (IV and V).

Catalyst materials which are characterized by such a chemical resistance under the conditions of the process for the endothermic, heterogeneously catalysed gas phase reaction to give synthesis gas are, for example, catalysts which comprise nickel or nickel compounds.

Catalyst materials which are characterized by such a chemical resistance under the conditions of the process for the exothermic, heterogeneously catalysed, oxidative coupling of methane with oxygen are, for example, catalysts which comprise lithium, samarium oxide, lanthanum oxide, barium carbonate, cerium oxide, sodium and/or nickel titanyl oxide.

All aforementioned catalysts can be applied to support materials. Such support materials typically include aluminium oxide, calcium oxide, magnesium oxide, silicon dioxide and/or titanium dioxide.

In the context of the present invention, specific surface area refers to the area of the catalyst material which can be reached by the process gas, based on the mass of catalyst material used.

A high specific surface area is a specific surface area of at least 1 m²/g, preferably of at least 10 m²/g.

The inventive catalysts are each present in the reaction zones and may be present in all manifestations known per se, for example fixed bed, moving bed.

Preference is given to the fixed bed manifestation for all reaction zones.

The fixed bed arrangement comprises a catalyst bed in the actual sense, i.e. loose, supported or unsupported catalyst in any form and in the form of suitable packings. The term “catalyst bed” as used here also includes continuous regions of suitable packings on a support material or structured catalyst supports. These would be, for example, ceramic honeycomb supports which are to be coated and have comparatively high geometric surface areas, or corrugated layers of metal wire mesh on which, for example, catalyst granules are immobilized. In the context of the present invention, a special form of packing is considered to be the presence of the catalyst in monolithic form. Such monolithic manifestations may also be foams composed of a support material, on which the aforementioned catalyst materials have been applied.

When a fixed bed arrangement of the catalyst is used, the catalyst is preferably in the form of beds of particles with mean particle sizes of 1 to 10 mm, preferably 2 to 8 mm, more preferably of 3 to 7 mm.

Likewise preferably, the catalyst is present in monolithic form in the case of a fixed bed arrangement. In the case of a fixed bed arrangement, particular preference is given to a monolithic catalyst which comprises nickel compounds supported on magnesium spinels.

When a catalyst in monolithic form is used in the reaction zones, in a preferred development of the invention, the catalyst present in monolithic form is provided with channels through which the process gases flow. Typically, the channels have a diameter of 0.1 to 3 mm, preferably a diameter of 0.2 to 2 mm, more preferably of 0.5 to 1.5 mm.

When a fluidized bed arrangement of the catalyst is used, the catalyst is preferably present in loose beds of particles, as have already been described in connection with the fixed bed arrangement.

Beds of such particles are advantageous because the particles possess a high specific surface area and, owing to their size, the mass transfer limitation of the reaction as a result of diffusion can be minimized This allows a high conversion rate to be achieved. At the same time, the particles are thus, however, still not so small as to result in a disproportionate increase in pressure drops in the course of flow through the fixed bed.

The ranges of the above-specified particle sizes are thus an optimum between the achievable conversion from the reactions according to the formulae (I to V) and the pressure drop obtained in the course of performance of the process. Pressure drop is directly coupled to the energy needed in the form of compressor output, such that a disproportionate increase therein would result in an uneconomic mode of operation of the process.

In a preferred embodiment of the process according to the invention, the conversion is effected in 7 to 25 and more preferably 10 to 20 series-connected pairs of reaction zones.

The reaction zones may either be arranged in one reactor or arranged divided between several reactors. The arrangement of the reaction zones in one reactor leads to a reduction in the number of apparatuses used.

The individual reaction zones and heat exchange zones may also be arranged together in one reactor or in any combinations of in each case reaction zones with heat exchange zones divided up in several reactors.

When reaction zones and heat exchange zones are present in one reactor, in an alternative embodiment of the invention, there is a thermal insulation zone between them, in order to be able to obtain adiabatic operation of the reaction zone.

In the manner described above, the reaction zones are preferably present in pairs in a reactor and are separated from one another by a thermal insulation zone.

In addition, individual series-connected reaction zones may independently also be replaced or supplemented by one or more parallel-connected pairs of reaction zones. The use of parallel-connected pairs of reaction zones allows, more particularly, the exchange or addition thereof with running continuous overall operation of the process.

Parallel—and series-connected pairs of reaction zones can especially also be combined with one another. More preferably, the process according to the invention, however, has exclusively series-connected reaction zones.

The reactors used with preference in the process according to the invention may consist of simple vessels with one or more reaction zones, as described, for example, in Ullmanns Encyclopedia of Industrial Chemistry (Fifth, Completely Revised Edition, Vol. B4, pages 95-104, pages 210-216), in which case thermal insulation zones may additionally be provided in each case between the individual reaction zones and/or heat exchange zones.

In an alternative embodiment of the process, there is thus a thermal insulation zone at least between one reaction zone and one heat exchange zone. There is preferably a thermal insulation zone around each reaction zone.

The catalysts or the fixed beds thereof are installed in a manner known per se on or between gas-permeable walls comprising the reaction zone of the reactor.

Especially in the case of thin fixed beds, technical apparatuses for homogeneous gas distribution may be installed upstream of the catalyst beds in flow direction. These may be perforated plates or other internals which bring about homogeneous entry of the process gas into the fixed bed by generating a low but homogeneous pressure drop.

In a preferred embodiment of the process, the inlet temperature of the process gas entering the first reaction zone of the exothermic, heterogeneously catalysed, oxidative coupling of methane with oxygen is from 550° C. to 850° C., preferably from 600° C. to 800° C., more preferably from 650° C. to 750° C.

In a likewise preferred embodiment of the process, the inlet temperature of the process gas entering the first reaction zone of the endothermic, heterogeneously catalysed gas phase reaction to give synthesis gas is from 650° C. to 950° C., preferably from 700° C. to 900° C., more preferably from 750° C. to 850° C.

In the process according to the invention presented here, at least on entry into the first reaction zone in each case, it is thus the case that the temperature of the process gases of the endothermic, heterogeneously catalysed gas phase reaction to give synthesis gas is higher than that of the process gases of the exothermic, heterogeneously catalysed, oxidative coupling of methane with oxygen.

The differences between the temperatures of process gases in the exothermic, heterogeneously catalysed, oxidative coupling of methane with oxygen, and the endothermic, heterogeneously catalysed gas phase reaction to give synthesis gas give rise to a significant advantage of the present invention. The processes involve preparing products which can be used together in similar subsequent processes, but one involves an endothermic reaction at temperatures which are significantly lower than in the case of the exothermic reaction. Thermal integration of the two processes can thus be effected in an advantageous manner by the process presented here.

In a further preferred embodiment of the process, the absolute pressure at the inlet of the first reaction zone of the exothermic, heterogeneously catalysed, oxidative coupling of methane with oxygen is between 1 and 15 bar, preferably between 1.5 and 10 bar, more preferably between 2 and 4 bar.

In a likewise further preferred embodiment of the process, the absolute pressure at the inlet of the first reaction zone of the endothermic, heterogeneously catalysed gas phase reaction to give synthesis gas is between 5 and 40 bar, preferably between 9 and 35 bar, more preferably between 25 and 30 bar.

In yet another, likewise further preferred embodiment of the process, the residence time of the process gas in all reaction zones of the endothermic, heterogeneously catalysed gas phase reaction to give synthesis gas together is between 0.05 and 60 s, preferably between 0.1 and 5 s, more preferably between 0.5 and 3 s.

The hydrocarbon, the carbon dioxide and the steam are typically supplied to the endothermic, heterogeneously catalysed gas phase reaction to give synthesis gas only upstream of the first reaction zone.

However, it is also possible to meter carbon dioxide and/or steam into the process gas if required upstream of one or more of the reaction zones which follow the first reaction zone.

The methane and the oxygen are typically supplied to the exothermic, heterogeneously catalysed, oxidative coupling of methane with oxygen only upstream of the first reaction zone. This has the advantage that the entire process gas is available for the absorption of heat of reaction in all reaction zones. Moreover, such a procedure can enhance the space-time yield, or reduce the mass of catalyst needed.

However, it is also possible to meter methane and/or oxygen into the process gas if required upstream of one or more of the reaction zones which follow the first reaction zone.

The supply of the process gases between the reaction zones can additionally control the temperature and the conversion. This is especially advantageous when the metered addition of individual process gases is to regulate the heat transfer in the downstream heat exchange zones. For this purpose, it is possible to meter in only process gases of the endothermic, heterogeneously catalysed gas phase reaction to give synthesis gas or only process gases of the exothermic, heterogeneously catalysed, oxidative coupling of methane with oxygen distributed upstream of the subsequent reaction zones. Alternatively, it is also possible, for particularly good temperature control, to meter in the process gases of both reactions distributed over the subsequent reaction zones, which is preferred.

After leaving a pair of reaction zones in each case, the process gases are passed through one or more of the abovementioned heat exchange zones, which are present downstream of the particular reaction zones.

These may be configured as heat exchange zones in the form of the heat exchangers known to those skilled in the art, for example tube bundle heat exchangers, plate heat exchangers, annular groove heat exchangers, spiral heat exchangers, finned tube heat exchangers, microheat exchangers. The heat exchangers are preferably microstructured heat exchangers.

In the context of the present invention, “microstructured” means that the heat exchanger, for the purpose of heat transfer, comprises fluid-conducting channels which are characterized in that they have a hydraulic diameter between 50 μm and 5 mm. The hydraulic diameter is calculated from four times the flow cross-sectional area of the fluid-conducting channel divided by the circumference of the channel.

In a preferred embodiment of the process, the series-connected pairs of reaction zones are operated at an average temperature which rises or falls from reaction zone to reaction zone of one of the two or of both reactions. This means that, within a sequence of pairs of reaction zones, the temperature from pair of reaction zones to pair of reaction zones can be allowed either to rise or to fall therein.

The heat exchange zones act as heat exchangers between the process gases of the reactions, which generally transfers heat from the process gases of the exothermic reaction to those of the endothermic reaction.

The flow regime of the particular process gases in the heat exchange zones may, for this purpose, be a cocurrent, a countercurrent or a crosscurrent.

The flow regime of the particular process gases in the heat exchange zones is preferably a countercurrent or crosscurrent, more preferably a countercurrent.

Such an embodiment in countercurrent is advantageous because this minimizes, according to thermodynamic principles which are common knowledge to those skilled in the art, the mean logarithmic temperature difference between the process gases in the heat exchange zones, thus allowing maximum heat currents to be transferred through the walls between the process gases of the two reactions.

The flow regime of the particular process gases in the pairs of reaction zones may, irrespective of the flow regime in the heat exchange zones, be parallel or opposing.

In the case of an opposing flow regime in the pairs of reaction zones, this means, for instance, that the first reaction zone of the endothermic, heterogeneously catalysed gas phase reaction to give synthesis gas is at the other end in flow direction from the first reaction zone of the exothermic, heterogeneously catalysed, oxidative coupling of methane with oxygen.

In a preferred development of the process according to the invention, a parallel flow regime is provided in the reaction zones.

It is particularly preferred here to implement a crosscurrent in the heat exchange zones.

This preferred development is advantageous because it allows the embodiment which is simple in apparatus terms and hence inexpensive, but simultaneously achieves better heat transfer through an arrangement offset by an angle of 90°, which is simple to obtain, of the process gas channels in the heat exchange zones, since, according to principles which are common knowledge to the person skilled in the art, the mean temperature difference between the process gases in the heat exchange zones is smaller in a crossflow arrangement.

The thickness of the reaction zones through which flow passes may be selected identically or differently and is determined according to principles which are common knowledge to the person skilled in the art from the above-described residence times and the particular amounts of process gas throughput in the process.

The maximum outlet temperature of the process gases leaving the first reaction zone of the endothermic, heterogeneously catalysed gas phase reaction to give synthesis gas is typically within a range from 550° C. to 850° C., preferably from 650° C. to 800° C., more preferably from 650° C. to 750° C. The person skilled in the art can freely determine the inlet temperatures of the subsequent reaction zones in the process according to the invention through the measures which follow, typically within the aforementioned limits.

The maximum outlet temperature of the process gases leaving the first reaction zone of the exothermic, heterogeneously catalysed, oxidative coupling of methane with oxygen is typically within a range from 650° C. to 950° C., preferably from 700° C. to 900° C., more preferably from 750° C. to 850° C. The person skilled in the art can freely determine the inlet temperatures of the subsequent reaction zones in the process according to the invention through the measures which follow.

In general, it is thus the case for the process according to the invention that the outlet temperatures of the process gases of the exothermic, heterogeneously catalysed, oxidative coupling of methane with oxygen at least downstream of the first reaction zone are higher than those of the process gases of the endothermic, heterogeneously catalysed gas phase reaction to give synthesis gas.

Together with the fact stated above that the inlet temperatures at least into the first reaction zone in each case have a reciprocal relationship, i.e. the inlet temperatures of the process gases of the exothermic, heterogeneously catalysed, oxidative coupling of methane with oxygen are below those of the process gases of the endothermic, heterogeneously catalysed gas phase reaction to give synthesis gas, the particular advantage of the process according to the invention arises. By virtue of such an inverse temperature relationship upstream and downstream of the particular reaction zones, the reaction enthalpy of the exothermic reaction can be exploited for the endothermic reaction by heat transfer in the heat exchange zone, while the process gases of the exothermic reaction are simultaneously cooled to a temperature which allows further, exothermically adiabatic conversion in the subsequent reaction zone under controlled conditions.

The temperature is further preferably controlled in the reaction zones through at least one of the following measures: dimensions of the adiabatic reaction zone, addition of further process gases between the reaction zones, molar ratio of the reactants and addition of secondary constituents, especially nitrogen, upstream of and/or between the reaction zones.

The composition of the catalysts in the inventive reaction zones may be the same or different. In a preferred embodiment, the same catalysts are used in each reaction zone. However, it is also advantageously possible to use different catalysts in the individual reaction zones.

For instance, especially in the first reaction zone when the concentration of the reactants is still high, a less active catalyst can be used, and the activity of the catalyst can be increased from reaction zone to reaction zone in the further reaction zones. The catalyst activity can also be controlled by diluting with inert materials or support material.

The process according to the invention is thus notable for high space-time yields for the individual reactions, associated with a reduction in the apparatus sizes and a simplification of the apparatus or reactors. This surprisingly high space-time yield is enabled by the interplay of the inventive and preferred embodiments of the novel process.

Especially the interplay of graduated, adiabatic reaction zones with heat exchange zones in between and the defined residence times enables exact control of the process and the resulting high space-time yields, and a reduction in the by-products formed.

Furthermore, the overall process is notable for an advantageous utilization of the reactants and an advantageous utilization of heat, which leads to a significant reduction in environmentally damaging carbon dioxide.

The present invention is illustrated by the example which follows and by figures, without restricting it thereto.

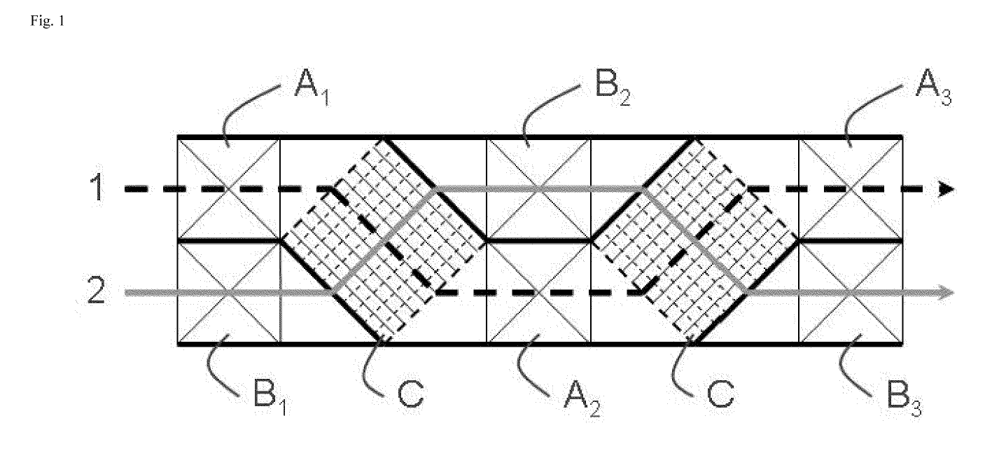

FIG. 1 shows a schematic diagram of a preferred embodiment of the process according to the invention, in which a first process gas stream (1) comprising methane, carbon dioxide and steam is fed to a first, adiabatic reaction zone (A₁) in which a first conversion to synthesis gas takes place. At the same time, a second process gas stream (2) comprising methane and oxygen is conducted in cocurrent with the first process gas stream (1) into a further adiabatic reaction zone (B₁). Between the reaction zones (A₁ and B₁) is a thermal insulation zone in the form of an insulating material (not shown). The process gases leaving the pair of reaction zones (A₁ and B₁) are then each conducted in crosscurrent through a heat exchange zone (C) in a structured plate heat transferer in which portions of the heat of reaction of the process gases in the process gas stream (2) are transferred to those of process gas stream (1). This is repeated twice by means of the further reaction zones (A₂, A₃, B₂, B₃) and further heat exchange zones (C).

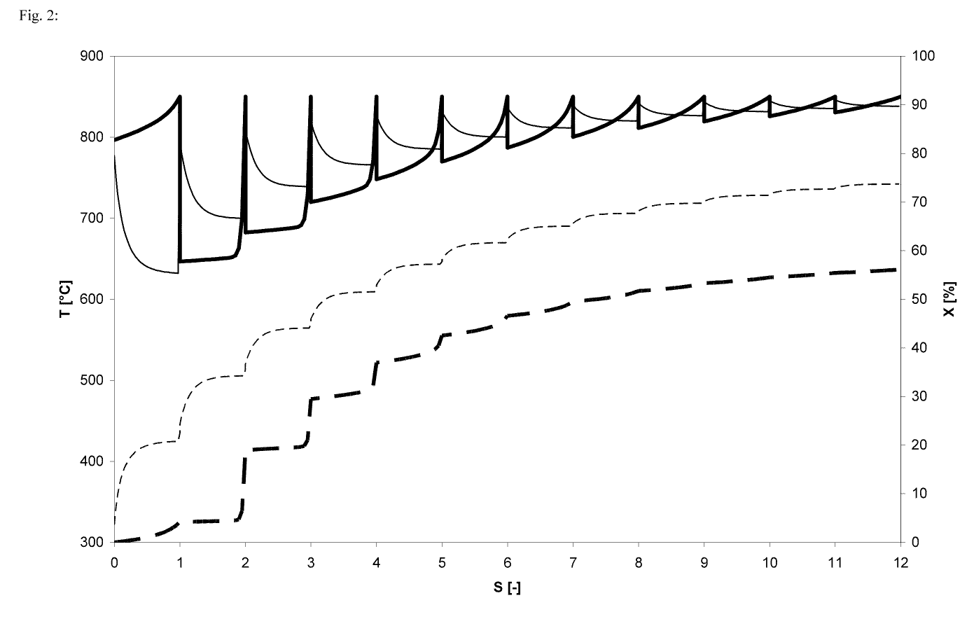

FIG. 2 shows temperature (T) and conversions (X) of methane over the individual reaction zones (S) and heat exchange zones according to Example 1 for the endothermic, heterogeneously catalysed preparation of synthesis gas (as thin lines in each case) and the exothermic, heterogeneously catalysed, oxidative coupling of methane (as thick lines in each case). Temperature plots are each shown as continuous lines; plots of the conversion of methane are each shown as broken lines.

### EXAMPLES

### Example 1

In this example, the endothermic, heterogeneously catalysed preparation of synthesis gas and the exothermic, heterogeneously catalysed, oxidative coupling of methane are performed in 12 pairs of adiabatic reaction zones.

The endothermic, heterogeneously catalysed preparation of synthesis gas comprises essentially reactions (I) to (III), conversion according to reactions (I) and (III) being clearly predominant over that according to reaction (II).

CH₄+H₂O [symbol] CO+3.H₂ (I)

CO+H₂O [symbol] CO₂+H₂ (II)

CH₄+2.H₂O [symbol] CO₂+4.H₂ (III)

The exothermic, heterogeneously catalysed, oxidative coupling of methane comprises essentially the reactions (IV) and (V).

4.CH₄+O₂→2.C₂H₆+2.H₂O (IV)

2.CH₄+O₂→C₂H₄+2.H₂O (V)

The setting of a molar ratio of methane (CH4) to water (H2O) of 1:2 and of a molar ratio of methane (CH4) to carbon dioxide (CO2) of 1:1 at the inlet of the first reaction zone for the endothermic, heterogeneously catalysed preparation of synthesis gas ensures that the reactions according to (I) and (III) are clearly predominant over that according to the formula (II).

In the case of the exothermic, heterogeneously catalysed, oxidative coupling of methane, a molar ratio of methane to oxygen of 10:1 is established at the inlet of the first reaction zone.

The two process gases with compositions as described above flow in each case over a total of 12 fixed catalyst beds composed of lanthanum oxide on a calcium oxide support in the case of the endothermic, heterogeneously catalysed preparation of synthesis gas, or through 12 fixed catalyst beds composed of cerium oxide in the case of the exothermic, heterogeneously catalysed, oxidative coupling of methane.

In other words, both process gases were passed through 12 reaction zones. Downstream of each reaction zone is a heat exchange zone in which the process gases are cooled in the case of the exothermic, heterogeneously catalysed, oxidative coupling of methane, or heated in the case of the endothermic, heterogeneously catalysed preparation of synthesis gas, before they enter the next reaction zone in each case. The cooling or heating was effected by the other process gas in each case. The activities of the catalysts used were identical in each case in the different reaction zones. In other words, the catalyst material was not diluted with inert material in any reaction zone of the process.

The pressure at the inlet of the first adiabatic reaction zone is set to 29 bar in the case of the endothermic, heterogeneously catalysed preparation of synthesis gas, and to 15 bar in the case of the exothermic, heterogeneously catalysed, oxidative coupling of methane.

The overall residence time of the process gases of the exothermic, heterogeneously catalysed, oxidative coupling of methane in the 12 reaction zones was 2.4 seconds.

The overall residence time of the process gases of the endothermic, heterogeneously catalysed preparation of synthesis gas in the 12 reaction zones was 0.5 seconds.

The test results from the above-described experiment are shown in FIG. 2. The individual reaction zones are shown here on the x-axis, such that a spatial profile of the evolutions of temperature and conversion in the process becomes visible.

On the left-hand y-axis is reported the temperature of the process gas both for the endothermic, heterogeneously catalysed preparation of synthesis gas and for the exothermic, heterogeneously catalysed, oxidative coupling of methane.

On the right-hand y-axis is reported the overall conversion of methane both for the endothermic, heterogeneously catalysed preparation of synthesis gas and for the exothermic, heterogeneously catalysed, oxidative coupling of methane.

The plot of the conversion over the individual reaction zones is shown as a broken line in each case.

The plot of the temperature over the individual reaction zones is shown as a continuous line in each case.

The temperature and the conversion based on the endothermic, heterogeneously catalysed preparation of synthesis gas are each shown as a thin line.

The temperature and the conversion based on the exothermic, heterogeneously catalysed, oxidative coupling of methane are each shown as a thick line.

It is evident that the inlet temperature of the process gas of the endothermic, heterogeneously catalysed preparation of synthesis gas upstream of the first reaction zone is about 750° C. As a result of the endothermic reaction to give synthesis gas under adiabatic conditions, the temperature in the first reaction zone falls to about 630° C., before the process gas is heated in the downstream heat exchange zone to about 800° C. from the heat drawn from the exothermic, heterogeneously catalysed, oxidative coupling of methane. The sequence of cooling and heating continues with decreasing distance between maximum and minimum temperatures and around a mean value of about 830° C.

At the same time, it is evident that the inlet temperature of the process gas of the exothermic, heterogeneously catalysed, oxidative coupling of methane upstream of the first reaction zone is about 800° C. As a result of the exothermic reaction according to (IV) and (V) under adiabatic conditions, the temperature in the first reaction zone rises to about 850° C. before the process gas in the downstream heat exchange zone releases a proportion of the heat to the process gas of the endothermic, heterogeneously catalysed preparation of synthesis gas, thus cooling it to about 645° C. The sequence of heating and cooling continues with decreasing distance between minimum and maximum temperatures and around a mean value of about 830° C.

A conversion of about 74% of the methane used at the inlet of the first reaction zone in the endothermic, heterogeneously catalysed preparation of synthesis gas, and a conversion of about 56% of the methane used at the inlet of the first reaction zone in the exothermic, heterogeneously catalysed, oxidative coupling of methane, calculated in each case from the remaining material at the outlet of the last reaction zone, are obtained.

1. Process for coproducing synthesis gas by endothermic, heterogeneously catalyzed gas phase reaction and ethylene by means of exothermic, heterogeneously catalyzed, oxidative coupling of methane, wherein the endothermic, heterogeneously catalyzed preparation of synthesis gas and the exothermic, heterogeneously catalyzed, oxidative coupling of methane are performed in at least three separate series-connected pairs of adiabatic reaction zones, a heat exchange zone being present between each pair of adiabatic reaction zones, in which the heat of reaction of the exothermic, heterogeneously catalyzed, oxidative coupling of methane from an upstream reaction zone is supplied at least partly through one wall to the process gases of the endothermic, heterogeneously catalyzed gas phase reaction to give synthesis gas which have been cooled in the upstream reaction zone.

2. Process according to claim 1, wherein the conversion is accomplished in 7 to 25.

3. Process according to claim 1, wherein the inlet temperature of the process gas entering the first of said three reaction zones of the exothermic, heterogeneously catalyzed, oxidative coupling of methane with oxygen is from 550° C. to 850° C.

4. Process according to claim 1, wherein the inlet temperature of the process gas entering the first of said three reaction zones of the endothermic, heterogeneously catalyzed gas phase reaction to give synthesis gas is from 650° C. to 950° C.

5. Process according to claim 1, wherein the catalysts are present in fixed bed arrangements in the reaction zones.

6. Process according to claim 5, wherein the catalysts are present as monoliths.

7. Process according to claim 1, wherein the flow regime of the process gases in the heat exchange zones is countercurrent or crosscurrent.

8. Process according to claim 1, wherein a parallel flow regime of the process gases is implemented in the reaction zones.

9. Process according to claim 1, wherein an opposing flow regime of the process gases is implemented in the reaction zones.

10. Process according to claim 9, wherein a parallel flow regime of the process gases is implemented in the reaction zones and the flow regime of the process gases in the heat exchange zones is in crosscurrent flow.

11. Process according to claim 1, wherein a thermal insulation zone is present around each of said reaction zones.

12. The process of claim 2, wherein the conversion is accomplished in 10 to 20 series-connected pairs of reaction zones.

13. The process of claim 3, wherein said inlet temperature is from 600° C. to 800° C.

14. The process of claim 13, wherein said inlet temperature is from 650° C. to 750° C.

15. The process of claim 4, wherein said inlet temperature is from 700° C. to 900° C.

16. The process of claim 15, wherein said inlet temperature is from 750° C. to 850° C.

17. The process of claim 7, wherein said flow regime is countercurrent.
